(19) United States
(12) Patent Application Publication
(10) Pub. No.: US 2008/0262131 A1
(43) Pub. Date: Oct. 23, 2008

(54) One-Component Aqueous Dispersion Adhesive

(76) Inventors: Martin Linnenbrink, Apensen (DE); Peter Kuehnemund, Frestedt (DE); Jurgen Mueller, Hamburg (DE)

Correspondence Address: BINGHAM MCCUTCHEN LLP, Three Embarcadero Center, San Francisco, CA, 94111-4067, US

(21) Appl. No.: 11/596,871

(22) PCT Filed: May 17, 2005
(86) PCT No.: PCT/EP05/52251

§ 371 Date: Feb. 8, 2008

(30) Foreign Application Priority Data
May 17, 2004 (EP) 04102159.3

(51) Int. Cl. C08K 5/1545; C08L 75/04

(52) U.S. Cl. 524/110; 524/507; 524/503

(57) ABSTRACT

The invention relates to one-component aqueous dispersion adhesives containing at least one copolymer A of monomers ethylene, vinyl acetate and, optionally, at least one (meth)acrylate and either at least one polyurethane with carboxyl groups and carbodiimide groups PUR-COOH-CDI or a mixture of a polyurethane with carboxyl groups PUR-000H and with a carbodiimide CDI. These dispersion adhesives are particularly well-suited for use as laminating adhesives and sealing adhesives. The invention also relates to the precoating of flat materials with a one-component aqueous dispersion adhesive.

### FIELD OF THE INVENTION

The invention relates to the field of one-component aqueous dispersion adhesives.

### BACKGROUND OF THE INVENTION

Dispersions have long been used as adhesives, especially in bonding textiles and sheets. Two-component polyurethane dispersion adhesives have been known for a relatively long time. However, two-component systems have the major disadvantage that the pot time, that is, the length of time in which the systems can still be processed after being mixed, is narrowly defined. Moreover, there is one additional work step for the user of mixing, and this can involve mistakes and hence lead to losses of quality.

To overcome these disadvantages, efforts have been made to formulate one-component polyurethane dispersion adhesives. For instance, European Patent Disclosure EP 1 013 690 A1 discloses a one-component aqueous dispersion based on a surface-deactivated polyisocyanate and an isocyanate-reactive polymer. International Patent Disclosure WO 00/11060 A1 and European Patent Disclosure EP 1 000 104 B1 describe one-component polyurethane dispersions which substantially contain on the one hand polymers that contain carbodiimides or carbodiimide groups and on the other polymers that contain carboxyl groups.

These one-component polyurethane dispersions are expensive on the one hand, and on the other they have disadvantages with regard to adhesion and durability in a hot and humid climate.

### SUMMARY OF THE INVENTION

The object of the present invention is therefore to make one-component aqueous dispersion adhesives available which overcome the disadvantages of the prior art. Surprisingly, it was discovered that one-component aqueous dispersion adhesives as defined by claim 1 attain this object.

These one-component aqueous dispersion adhesives are distinguished, among other features, in that by using the more-economical copolymer A, the price for the aqueous dispersion adhesive is reduced without sacrifices in terms of the essential properties. It has furthermore been demonstrated that the one-component aqueous dispersion adhesives of the invention achieve improved adhesion to plastics as well as an improvement in the durability of the bond in a hot and humid climate.

Under certain circumstances, an improvement in the initial strength after bonding and an improvement in surface tack have also been found.

The one-component adhesives of the invention are especially well suited as laminating adhesives and sealing adhesives.

### WAYS OF EMBODYING THE INVENTION

The present invention relates to one-component aqueous dispersion adhesives which contain at least one copolymer A of the monomers ethylene, vinyl acetate, and optionally at least one (meth)acrylate as well as either at least one polyurethane having carboxyl groups and carbodiimide groups, or a mixture of a polyurethane having carboxyl groups and a carbodiimide.

As the copolymer A, on the one hand ethylene/vinyl acetate copolymers (EVA) and on the other copolymers of the monomers ethylene/vinyl acetate (meth)acrylate are suitable.

As (meth)acrylate monomers, in principle all esters of acrylic acid and methacrylic acid can be used; depending on the applications and requirements of the adhesives from this class, specific monomers or monomer mixtures are selected. It has been found that it is advantageous if the (meth)acrylate is an acrylate. (Meth)acrylate monomers which are selected from the group including 2-ethylhexyl acrylate, 2-hydroxyethyl acrylate and 2-hydroxypropyl acrylate and 2-hydroxybutyl acrylate and mixtures thereof have proved especially suitable. For the production of the copolymer A, not only ethylene and vinyl acetate but also one or two monomers of the (meth)acrylate monomers described are used and a terpolymer or quaterpolymer is thus produced.

The ratios of the segments originating in the monomers used in the copolymer A may vary widely. The ethylene/vinyl acetate weight ratio is preferably 1 or less, in particular less than 0.66, and even more preferably less than 0.4. The content of the sum of all the (meth)acrylate segments is furthermore less than 50 weight-%, and in particular less than 35 weight-%, of the copolymer A.

Aqueous dispersion adhesives which include the mixture of copolymers A as described above have proved especially suitable. Mixtures of a copolymer A comprising ethylene and vinyl acetate and at least one copolymer A comprising ethylene and vinyl acetate and at least one (meth)acrylate have proved to be especially suitable.

The one-component aqueous dispersion adhesive furthermore contains either at least one polyurethane having carboxyl groups and carbodiimide groups (hereinafter each called PUR-COOH-CDI), or a mixture of a polyurethane having carboxyl groups (hereinafter each called PUR-COOH) and a carbodiimide (hereinafter called CDI).

Polyurethanes having carboxyl groups PUR-COOH are polyurethanes which have at least two carboxyl groups per macromolecule. Such compounds have long been known and are used in the formulation of aqueous polyurethane dispersions. Typically, these are produced from polyisocyanates and compounds that have carboxyl groups and NCO-active groups and optionally typical polyols, in particular diols. Examples of such compounds that have carboxyl groups and NCO-active groups are aminocarboxylic acids, hydroxycarboxylic acids, in particular dihydroxycarboxylic acids, such as dimethylol propionic acid, or diolcarboxylic acids that are structurally similar to them. It has been found that highly suitable polyurethanes having carboxyl groups PUR-COOH are those as described for instance as “polymer (PII)” in German Patent Disclosure DE 100 00 656 A1 or International Patent Disclosure WO 01/34559 A1.

Carbodiimides are compounds which contain at least one carbodiimide group —N═C═N—, but no carboxyl groups. Especially suitable carbodiimides CDI are those which have the structural element of formula I:

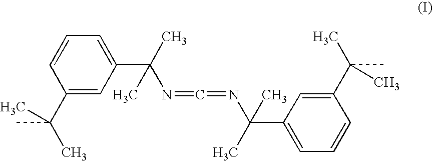

Especially suitable carbodiimides CDI of this kind are for instance described as “carbodiimides Ibii” in WO 00/11060.

Polyurethanes having carboxyl groups and carbodiimide groups PUR-COOH-CDI are polyurethanes which besides carboxyl groups also contain carbodiimide groups —N═C═N—.

Especially suitable polyurethanes having carboxyl groups and carbodiimide groups PUR-COOH-CDI are those which have the structural element of formula (I):

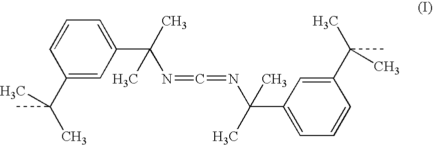

Such compounds are described are described for instance in German Patent Disclosure DE 100 01 777 A1 or as “polymers (Ia)” in EP 1 000 104 B1.

Under certain circumstances, it has proved advantageous that the dispersion adhesive simultaneously contains at least one carbodiimide CDI and at least one polyurethane having carboxyl groups and carbodiimide groups PUR-COOH-CDI.

It can be advantageous that the aqueous dispersion adhesive simultaneously contains at least one polyurethane having carboxyl groups and carbodiimide groups PUR-COOH-CDI and at least one polyurethane having carboxyl groups PUR-COOH.

The aqueous dispersion adhesive furthermore includes water. The proportion of water in the aqueous dispersion adhesive typically amounts to between 70 weight-% and 40 weight-%, and in particular between 55 weight-% and 45 weight-%.

The weight ratio of A to the sum of PUR-COOH-CDI and PUR-COOH is preferably between 0.1 and 10, in particular between 1 and 6. If the proportion of polyurethane, that is, the sum of PUR-COOH-CDI and PUR-COOH, is less, then on the one hand a reduction in the cross-linking density and hence in the strength occurs, and on the other, a worsening in the resistance to heat can be observed. On the other hand, the resistance to PVC softeners, which are present in many substrates to be bonded with the dispersion adhesive, drops sharply. Finally, a higher temperature for processing is often necessary. If the proportion of polyurethane is higher, then the advantages found for the present invention are no longer particularly pronounced, and the properties no longer differ substantially from the known one-component polyurethane dispersion adhesives.

In one embodiment of the invention, the one-component aqueous dispersion adhesive furthermore contains at least one poly(meth)acrylate. Such poly(meth)acrylate is typically copolymers and is dispersible.

It is furthermore been demonstrated that the dispersion adhesive advantageously contains stabilizers. In principle, these dispersions, but it has been found that the use of stabilizers leads to dispersion adhesives with a very long shelf life, if the stabilizer is selected from the group including wetting agents, cellulose, polyvinyl alcohol, polyvinyl pyrrolidone, and mixtures thereof.

The aqueous dispersion adhesive can furthermore contain at least one of the further ingredients that is selected from the group including thickening agents, anti-aging agents, fungicides, pigments, colorants, wetting agents, antifoaming agents, matting agents, and fillers.

Aqueous dispersion adhesives which are free of organic solvents, especially free of so-called VOCs (volatile organic compounds) and/or softeners, are especially advantageous. Both softeners and organic solvents are disadvantageous from the standpoint of both ecotoxicology and work hygiene. Moreover, softeners can migrate to the surface of an adhesive and cause failure of a bond or can cause the surface to become tacky, which leads to soiling of the adhesive seams. Solvents are also unwanted, since on the one hand they can have an additional risk potential during heating and application of the adhesive, and on the other because they too can migrate and over the long term be released to the environment and given off to materials which are in contact with the adhesive and can adversely affect them or lead to failure of the bond.

The production of the dispersion adhesive is done in the usual way for dispersion adhesives. The ingredients, that is, copolymer A, polyurethane having carboxyl groups and carbodiimide groups PUR-COOH-CDI, or polyurethane having carboxyl groups PUR-COOH/carbodiimide CDI, can be processed together into a dispersion, or different dispersions of A, polyurethane having carboxyl groups and carbodiimide groups PUR-COOH-CDI or polyurethane having carboxyl groups PUR-COOH, can be mixed together. Preferably, a dispersion of a copolymer A is used which is adjusted to a pH of over 7, and in particular to a pH of between 7.5 and 8.5. The adaptation of the pH is typically done with ammonia, organic amines, or an aqueous lye of an alkali hydroxide, in particular an aqueous sodium hydroxide solution.

Next, this dispersion of the copolymer A is mixed with a dispersion of a polyurethane having carboxyl groups and carbodiimide groups PUR-COOH-CDI, or with a dispersion of a polyurethane having carboxyl groups PUR-COOH.

The carbodiimide CDI can be added as needed after the mixing of the dispersions, or it can be added to the dispersion of the copolymer A or to the dispersion of the polyurethane PUR-COOH or optionally to the dispersion of the polyurethane PUR-COOH-CDI.

The preferred production methods include the steps of presenting the dispersion of the copolymer A; addition while stirring of a neutralization agent to a pH value of 7.0 to 9.0, in particular between 7.5 and 8.5; addition while stirring of the dispersion of a polyurethane having carboxyl groups and carbodiimide groups PUR-COOH-CDI, or of the dispersion of a polyurethane having carboxyl groups PUR-COOH; optionally addition while stirring of CDI; addition of any additives; monitoring the pH value; and adjusting the viscosity by means of a thickening agent.

The one-component dispersion adhesive of the invention experiences cross-linking, by the addition of heat, forming N-acyl ureas, resulting in enhanced bonding (cohesion). This heat treatment takes place at a temperature of between 50° C. and 190° C., in particular between 60° C. and 140° C.

The dispersion adhesive can be used for bonding the most various materials, especially plastics, metals, painted surfaces, textiles, foams, leather, paper, cardboard, wood, derived timber products, or natural fiber materials. It is understood to be possible that different materials can be bonded together.

The dispersion adhesive according to the invention is isocyanate-free and is therefore extremely advantageous for work-hygiene and ecological reasons.

The dispersion adhesive of the invention has one component. As a consequence—entirely unlike two-component dispersions—the adhesive has no pot life. As a result, the adhesive can be stored at room temperature for a very long time, typically more than 6 months and at least more than 4 months, without the adhesive properties being adversely impaired. Moreover, no mixing whatever has to be done by the user, and thus the risk of inadequate bonding from mixing mistakes is absent. Finally, by the use of a one-component dispersion, complicated rinsing operations for the tools and equipment as well as supply lines are for the most part dispensed with as well.

The dispersion adhesive is typically used in various ways.

In wet bonding, the adhesive is applied to the surface of the body or bodies to be bonded and immediately thereafter joined in the wet state and optionally pressed. However, at least one of the partners in the bonding must be capable of absorbing the moisture present in the joint, or the water must be capable of diffusing through it. The strength increases to the extent that the water disappears from the bonding joint. The strength takes place in the first step as a result of a physical process, namely evaporation of the water and the attendant solidification by film formation. In the second step, heat must then be added for the chemical cross-linking.

In contact bonding, the dispersion adhesive is applied to the surface of the bodies to be bonded. As soon as the water has evaporated, or as soon as a solid film of adhesive has formed, the thus-coated bodies are joined and pressed within the open period, creating an adhesive bond. A distinction is made between cold-contact and warm-contact bonding. In warm-contact bonding, the adhesive is activated by supplying heat before the joining and pressing.

In bonding by applying adhesive to one side, the dispersion adhesive is applied to the surface of one of the bodies to be bonded. As soon as the water has evaporated, or as soon as a solid adhesive film has formed, thus-coated bodies are joined to a joining partner within the open period. If this joining takes place at room temperature, for instance, and under pressure, then the term PSA (pressure sensitive adhesive) or self-adhesive is typically used. If the joining is done at elevated temperature and under pressure, the term is typically sealing adhesive. The use of the one-component aqueous dispersion adhesive as a sealing adhesive is preferred.

The one-component aqueous dispersion adhesive of the invention can be used as a laminating adhesive. In this case a flat material, typically called a decoration, is bonded to a solid, shaped substrate (so-called carrier). To that end, either vacuum deep drawing or the press-lining method is employed.

In vacuum deep drawing, the dispersion adhesive is applied to the substrate. Drying follows, which in the present invention is done at room temperature or in the drying channel at a maximum of 40° C. Typically, the sheet (decoration comprising air-impermeable material) is fastened in airtight fashion in a frame. Below the sheet is a bottom mold onto which the substrate is placed. The bottom mold and substrate are drilled through or air-permeable. The equipment is further closed off in airtight fashion underneath. When air is extracted from this apparatus, the decorative material, under the atmospheric pressure bearing on its surface, conforms to a precise fit to the substrate part. The decorative material is heated before the vacuum is applied. The decorative material is air-impermeable because of the vacuum to be generated. As a rule, the decoration is a plastic sheet.

In the press-lining method, the adhesive is likewise applied to the substrate and optionally to the decoration, but at least to the substrate. Whether the adhesive is also applied to the decorative material depends among other factors on the material itself. For instance, the adhesive is applied solely to the substrate if the decorative material typically comprises a textile with a foam backing, for instance on the order of an open-pore cut polyurethane foam. If the decorative material is purely of textile, carpet, or leather, then normally applying adhesive to both sides of the substrate and the decoration is necessary. This is followed by drying, typically at room temperature or in the drying channel at a maximum of 40° C. The bonding of the substrate with the decoration takes place after heat activation with joining and pressing.

In all the applications described, the application of adhesive can be done in various ways, whether by spraying, rollers, or by pouring. However, in spray application of the adhesive—and this method is preferentially used—the problem of what is known as overspray must be taken into account.

It has now surprisingly been discovered that with the one-component aqueous dispersion adhesive of the invention, even flat materials, especially decorative materials comprising sheets, can be precoated, in particular without spray application, and then bonded by the sealing or hot-contact bonding method. The decorative material, or its surface, can comprise the most various materials, in particular plastic, textile, foam, leather, paper, or cardboard. Particularly plastics and preferably plastic sheets based on PVC (polyvinyl chloride), TPO (thermoplastic olefin elastomer), ASA (acrylonitrile/styrene/acrylic acid ester), EVA (ethylene/vinyl acetate), PUR (polyurethane), PA (polyamide), or PETP (polyethylene terephthalate) have proven suitable.

Since the sheets are precoated, a longer time can elapse between the coating and the bonding. This is important especially whenever the coating and bonding are done at different places. For instance, the sheet can be coated by the sheet manufacturer and then stored for a relatively long time and supplied to the factory that then bonds this precoated sheet to a substrate. Despite this long period of time between the precoating and the bonding, a perfect bond can be assured. This advantage is especially important because in the industry, especially automobile manufacture, there is a trend in production “away from the line to the vendor”. This trend in turn continues between the direct vendor—for example of decorative materials.

The application to flat decorative material is expediently done using squeegee or roller application systems. This is made possible particularly because of the extremely long open period of the dispersion adhesive of the invention. Thus the problem of overspray no longer exists, either. Coating of the decoration, primarily the sheet or textile, can already be done by the manufacturer. The one-component dispersion adhesive is implied in that case to the sheet, such as a TPO sheet, preferably by means of squeegee or roller application systems. The coated sheet is expediently passed after that through a drying channel, in which the water is extracted from the adhesive and the film formation takes place. After that, the precoated sheet passes over cooling rollers before being wound up at room temperature.

The adhesive of the invention is distinguished in that a film of the dispersion adhesive, applied to a substrate and dried, is essentially nontacky at room temperature, both before and after curing. A decoration or sheets coated in this way can therefore be stored and shipped without problems until they are further processed, without for instance requiring the placement of separation papers, such as silicone-coated papers. The shelf life depends on the material to be coated. In the case of precoating a TPO sheet discussed above, the shelf life at a storage temperature of up to 30° C. is for instance several months.

Decorations, in particular sheets, coated in this way are then used as blanks in the laminating factory. These coated decorations or sheets are placed in the laminating tool and activated by heat before being joined to a further surface. Next, they are bonded, particularly by sealing bonding or hot-bonding contacting, so that finally the bonded article is obtained. A further advantage of this process is that in the laminating factory, the drying line is omitted, so that the entire laminating process is markedly simplified, which therefore has financial advantages.

Today, the adhesive is sprayed in the laminating factory, which requires extraction by suction. This is done, so that the material will not get into the air, behind a filter wall or a water wall. The water, impregnated with adhesive particles, is then processed with precipitating agents by the floatation method. The resultant sludge, or the filter material of the filter wall, must then be disposed of. The novel method described above is a contrast to this; it uses precoated decorations, and these costs for disposing of soiled filter walls and optionally costs for precipitating agents and for the precipitation sludge are eliminated. Rinsing and cleaning the system and equipment are also greatly reduced, leading to massive cost savings and ecological and work-hygiene advantages.

The dispersion adhesive of the invention is therefore distinguished by the fact that it can be processed simply, can be used in processes that cause no overspray, and has excellent properties with at the same time a favorable price.

The dispersion adhesive is typically applied to the surface to be bonded in a quantity of from 30 to 200 g/m² when wet, preferably 60 to 120 g/m² when wet.

The one-component aqueous dispersion adhesive is preferably used for the production of decorative internal laminating parts in automobile construction made by the laminating process, such as dashboards, interior door parts rear shelves, headliners, sunroof liners, center consoles, glove compartments, visors, posts, door handles and armrests, floor, cargo-area and trunk groups, and walls of sleeping compartments and rear areas of delivery trucks and other trucks.

### EXAMPLES

The examples listed below serve to illustrate the invention.

Production of One-Component Aqueous Dispersion Adhesives

TABLE 1
Raw Materials Used.

| Raw | | |
|---|---|---|
| Materials | | Description |
| EVA-1 | A | EVA dispersion |
| | | Ethylene/vinyl acetate = 17%/83% |
| | | Viscosity* = 3800 ± 1000 MPas |
| | | ph = 4-5 |
| | | Water content: 40 ± 1% |
| EVAA-1 | A | Ethylene/vinyl acetate/acrylate dispersion |
| | | Ethylene/vinyl acetate/2-ethylhexylacrylate = |
| | | 25%/50%/25% |
| | | Viscosity* = 2000 ± 1000 mPas |
| | | ph = 3-5 |
| | | Water content: 35 ± 1% |
| EVAA-2 | A | Ethylene/vinyl acetate/acrylate dispersion |
| | | Ethylene/vinyl acetate/hydroxyethylacrylate = |
| | | 15%/80%/5% |
| | | Viscosity* = 1000-4500 mPas |
| | | pH = 4.5-5.5 |
| | | Water content: 49 ± 1% |
| PU-1 | PUR-COOH—CDI | PUR dispersion having COOH and |
| | | carbodiimide groups |
| | | Viscosity** = 500-300 mPas |
| | | Particle size = ca. 0.1 μm |
| | | k value per Fikentscher = ca. 30-60 |
| | | Film tear strength = ca. 30 N/mm2 |
| | | Film elongation at tear = ca. 800% |
| | | Water content: 60% |
| CDI-1 | A | Oligocarbodiimide |
| | | Carbodiimide content (relative to |
| | | polymer) = ca. 12%, ca. 3 mol/kg |
| | | Viscosity*** = 10-500 mPas |
| | | pH = 8-10 |
| | | Water content: 80% |
| Borchi ® Gel L 75N | | PUR-based thickener |
| (Borchers GmbH) | | |

*Brookfield RVT 3/20 (ISO 2555)
**(23° C., 250 s⁻¹, per DIN ISO 976)
***(23° C., 250 s⁻¹, per DIN EN ISO 3219)

The production of examples B1, B2, and B3 according to the invention is done as follows:

The aqueous dispersion of the copolymer or copolymers A was placed in a mixing vessel. After adjustment of the pH to a value between 7.5 and 8.5 by adding caustic soda, the polyurethane dispersion was stirred in. Next, the carbodiimide was stirred in if applicable. After further stirring for approximately 20 minutes, the viscosity of the dispersion adhesive was adjusted by means of thickeners to a viscosity of between 5000 and 7000 mPas. The viscosity is measured here at 20° C. by means of a Brookfield viscosimeter RVT with a spindle ⅗ UpM. All the examples yielded a homogeneous white dispersion with a long shelf life.

TABLE 2
Dispersion Adhesive Compositions

| | B1 | | B2 | | B3 | |
|---|---|---|---|---|---|---|
| EVA-1 | 50 | g | 50 | g | 50 | g |
| EVAA-1 | | | | | 25 | g |
| EVAA-2 | | | | | 10 | g |
| PU-1 | 50 | g | 50 | g | 50 | g |
| CD-1 | | | 5 | g | 5 | g |
| Borchi ® | 0.2 | g | 0.2 | g | 0.2 | g |
| Gel ® L 75 N | | | | | | |
| NaOH (25%- | 0.2 | g | 0.2 | g | 0.2 | g |
| ig in H₂O) | | | | | | |

| | | | |
|---|---|---|---|
| Proportion | 50 weight - % | 51 weight - % | 48% weight - % |
| of water | | | |
| Viscosity | 5000-6000 mPas | 5000-6000 mPas | 5000-6000 mPas |

As a reference example Ref. for a two-component polyurethane dispersion adhesive, SikaTherm 4120 was used as the A component and SikaCure 4901 was used as the B component (both commercially available from Sika AG in Switzerland) in a mixture ratio of A/B of 100/5 (w/w).

Production of the Bonds

The adhesives were applied with a spray gun from Walther (type: HVLP system, nozzle opening 1.8) to a plane ABS substrate (150 mm×50 mm) Cycolac G 360 made by General Electric. The adhesive application extended over two-thirds of the specimen body surface, because the remaining one-third was needed at the end of the test body surface for fastening the test body. The result was a teardrop-shaped application pattern. The quantity of adhesive applied was 80-100 g/m² when wet. After a drying time of one hour at room temperature, a 1.2 mm thick primed PVC sheet (Benecke-Kaliko, Hannover, Germany, in black, of the kind used in the VW Golf A4) was joined to the substrate and pressed in a plate press with a pressing pressure of 1.0-0.8 Kp/cm². In this operation, the plate of the press facing toward the sheet was heated (95° C.), and the activation temperature required for the sealing operation of 65° C. in the adhesive joint was attained by heating through the sheet. The sealing temperature of 65° C. needed for the sealing operation was achieved in the existing plate press (Rohde+Walter, 26180 Rastede, Germany, type: LP30) within 30 seconds. The temperature adjustment, testing and monitoring were done with a temperature sensor in the joint region between the ABS substrate and the PVC sheet.

Before the ensuing testing process, there is a waiting period of 5 days at room temperature.

Specimen bodies were also produced on the one hand in which there was a waiting period of 24 hours after the application of the adhesive until the bonding took place (“open time 24 h”).

Finally, specimen bodies with aged dispersion adhesive were done. In this case the adhesive was stored for 14 days at room temperature (“KL 14 d/RT”), 14 days at 40° C. (“KL 14 d/40° C.”), 6 weeks at room temperature (“KL 6 w/RT”), or 6 weeks at 40° C. (“KL 6 w/40°”), before the test body was completed.

Testing Process

Floating Roller Peel Strength (per DIN EN 1464)

In the floating roller peel test itself, the test body, after each period of storage, was stored for 5 days at room temperature (23° C./50% relative humidity), optionally subjected to a heat and humidity stress, and then stored for 30 minutes each at 100° C., before also being peeled at that temperature in an air-conditioned apparatus.

The test bodies were tested as follows:
after 5 days' storage in a normal climate (23° C./50% relative humidity (“final strength” or EF) (without additional heat and humidity stress)
after 10 days' storage in a high-humidity climatic test cabinet at 40° C. and 96% relative humidity (“Testor”) (additional heat and humidity stress)
after 10 days in the hot cabinet at 100° C. (“high-temperature aging”) (additional heat and humidity stress)

In the tests with additional heat and humidity stress, that is, “hot” or “Testor” storage, the test bodies were conditioned for an additional 24 hours at room temperature before being delivered to the floating roller peel test.

Shelf Life

Specimens each of 5 kg were stored on the one hand at room temperature (RT) and on the other at 40° C. in the drying cabinet. At regular intervals of every 14 days, the specimens were checked extremely carefully visually and with the aid of a spatula for sedimentation, creaming, coagulation, and possibly a major change in viscosity.

Summer Simulation

Specimens each of 5 kg were stored on the one hand at room temperature and on the other at 60° C. in the drying cabinet for 3 days. These specimens were examined for cross-linking reactions in the rheometer:

Measurement apparatus: Modular Compact Rheometer, type MCR300 SN616966 (from Physika, 73760 Ostfildern, Germany)

Method: oscillation test, deformation amplitude gamma=0.5%, f=1 Hz, normal force FN=15N, temperature TC 20/P-ETD 400 T 0 20 . . . 120° C. lin, continuous ramp.

From the curve course of the storage module G′, loss module G″, and loss factor tang δ before and after storage, the extent of cross-linking was ascertainable.
Assessment: Curves congruent->“no cross-linking” Curves not congruent->“slight” or “severe cross-linking”

### Results

TABLE 3
Strengths of the Bonds

| | B1 | B2 | B3 | Ref. |
|---|---|---|---|---|
| Floating Roller Peel | | | | |
| Strength (N/5 cm) | | | | |
| After 5 d/RT EF | 37.0 | 38.8 | 34.7 | 28.5 |
| After 10 d Testor | 26.6 | 26.2 | | 20.2 |
| After 10 d/100° C. | 37.0 | 35.0 | 28.1 | 15.7 |
| Open period 24 h EF | 29.9 | 32.6 | | |
| KL 14 d/RT EF | 32.2 | 40.2 | | |
| KL 14 d/40° EF | 40.7 | 34.5 | | |
| KL 6 w/RT EF | 33.6 | 42.2 | | |
| KL 6 w/40° EF | 34.9 | 34.6 | | |
| Storage Life | | | | |
| 2 Months RT | stable | stable | fully | n.a. |
| | slightly Agglomerate | slightly Agglomerate | stable | |
| | slightly homog.* | slightly homog.* | | |
| 2 Months 40° C. | slight | slight | fully | n.a. |
| | creaming | creaming | stable | |
| 3 d 60° C. | | | fully stable | n.a. |
| | | | no crosslinking | |

*homog. = homogenizable

From the results of Table 3, it can be seen that the bonds, by means of examples B1, B2 and B3 according to the invention, have significantly greater strengths and heat resistances than the comparative example Ref. and thus represent suitable dispersion adhesives for industry.

The dispersion adhesives B1, B2 and B3 of the invention, after their application and drying at room temperature, were essentially nontacky, as was ascertained from testing using the back of a finger.

1. A one-component aqueous dispersion adhesive, containing
at least one copolymer A of the monomers ethylene, vinyl acetate, and optionally at least one (meth)acrylate
and
either at least one polyurethane having carboxyl groups and carbodiimide groups PUR-COOH-CDI
or a mixture of a polyurethane having carboxyl groups PUR-COOH and a carbodiimide CDI.

2. The one-component aqueous dispersion adhesive as defined by claim 1, characterized in that it simultaneously contains at least one carbodiimide CDI and at least one polyurethane having carboxyl groups and carbodiimide groups PUR-COOH-CDI.

3. The one-component aqueous dispersion adhesive as defined by claim 1, characterized in that it simultaneously contains at least one polyurethane having carboxyl groups and carbodiimide groups PUR-COOH-CDI and at least one polyurethane having carboxyl groups PUR-COOH.

4. The one-component aqueous dispersion adhesive as defined by claim 1, characterized in that the copolymer A is a copolymer comprising ethylene and vinyl acetate.

5. The one-component aqueous dispersion adhesive as defined by claim 1, characterized in that the copolymer A is a copolymer comprising ethylene and vinyl acetate and at least one (meth)acrylate.

6. The one-component aqueous dispersion adhesive as defined by claim 1, characterized in that the dispersion adhesive contains a mixture of at least one copolymer A comprising ethylene and vinyl acetate and of at least one copolymer A comprising ethylene and vinyl acetate and at least one (meth)acrylate.

7. The one-component aqueous dispersion adhesive as defined by claim 1, characterized in that the (meth)acrylate is an acrylate, selected in particular from the group including 2-ethylhexyl acrylate, 2-hydroxyethyl acrylate and 2-hydroxypropyl acrylate and 2-hydroxybutyl acrylate and mixtures thereof.

8. The one-component aqueous dispersion adhesive as defined by claim 1, characterized in that the carbodiimide CDI and/or the polyurethane having carboxyl groups and carbodiimide groups PUR-COOH-CDI has the structural element of formula (I):

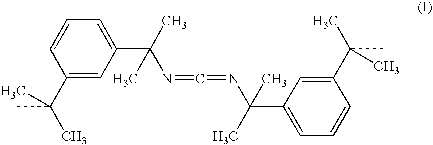

9. The one-component aqueous dispersion adhesive as defined by claim 1, characterized in that the weight ratio of A/(PUR-COOH-CDI+PUR-COOH) is between 0.1 and 10, in particular between 1 and 6.

10. The one-component aqueous dispersion adhesive as defined by claim 1, characterized in that the dispersion adhesive further includes a poly(meth)acrylate.

11. The one-component aqueous dispersion adhesive as defined by claim 1, characterized in that the dispersion adhesive further includes a stabilizer, selected from the group including wetting agents, cellulose, polyvinyl alcohol, polyvinyl pyrrolidone, and mixtures thereof.

12. The one-component aqueous dispersion adhesive as defined by one of the foregoing claims, characterized in that the dispersion adhesive is cross-linked at a temperature of between 50° C. and 190° C., in particular between 50 and 140° C., and preferably between 60° C. and 80° C.

13. The one-component aqueous dispersion adhesive as defined by claim 1, characterized in that a film of the dispersion adhesive, applied to a substrate and dried, is essentially nontacky at room temperature both before and after curing.

14. The use of an aqueous dispersion adhesive as defined by claim 1 for coating a surface, in particular a flat material, preferably a sheet.

15. The use as defined by claim 14, characterized in that the surface to be coated comprises plastic, textile, foam, leather, paper, or cardboard.

16. The use of an aqueous dispersion adhesive as defined by claim 1 for bonding plastics, metals, painted surfaces, textiles, foams, leather, paper, cardboard, wood, derived timber products, or natural fiber materials.

17. The use of an aqueous dispersion adhesive as defined by claim 1 for laminating surfaces with flat materials, in particular comprising plastics, textiles, foams, leather, paper, or cardboard.

18. A coated article, characterized in that it has been coated with an aqueous dispersion adhesive as defined by claim 1.

19. The coated article as defined by claim 18, characterized in that the coated article is a coated sheet.

20. A bonded article, characterized in that it has been bonded with an aqueous dispersion adhesive as defined by claim 1.

21. The bonded article as defined by claim 20, is put in contact with a further surface and then bonded by heating.

22. The bonded article as defined by claim 21, characterized in that the article is bonded in the sealing process.
